(19) United States
(12) Patent Application Publication
(10) Pub. No.: US 2006/0139148 A1
(43) Pub. Date: Jun. 29, 2006

(54) Method, apparatus and system for controlling access to a cabinet

(76) Inventors: Todd J. Faro, West Covina, CA (US); Charles L. King, Claremont, CA (US)

Correspondence Address: CHALKER FLORES, LLP, 2711 LBJ FRWY, Suite 1036, DALLAS, TX, 75234, US

(21) Appl. No.: 11/021,285

(22) Filed: Dec. 23, 2004

(51) Int. Cl. G05B 19/00

(52) U.S. Cl. 340/5.73; 340/5.51

(57) ABSTRACT

The present invention provides a system, method and apparatus for controlling access to a cabinet having one or more lockable compartments, at least one locking/unlocking apparatus for the one or more lockable compartments, a user access device communicably coupled to the locking/unlocking apparatus and a power supply electrically connected to the at least one locking/unlocking apparatus and the user access device. The user access device includes a user interface, a data storage device and a processor. The user interface receives user access data. The data storage device stores the received user access data, other access activity information and the user access data for one or more authorized users. The processor compares the received user access data with the user access data for the one or more authorized users and controls the locking/unlocking apparatus based on the comparison.

### TECHNICAL FIELD OF THE INVENTION

The present invention relates, in general, to the field of security, and in particular, to a method, apparatus and system for controlling access to a cabinet.

### BACKGROUND OF THE INVENTION

Without limiting the scope of the invention, the background of the invention is described in connection with controlling access to file cabinets, as an example. Controlling access to the contents of file cabinets, such as documents, valuables, expensive equipment and other important information or items, has always been important. As a result, one or more keyed locks mounted on the cabinet are used to control access to the contents of cabinet. If more security is needed, the cabinets are typically placed in a secured room to which only authorized personnel had access. The security of the room containing the cabinets and consequently the complexity of the security system used to obtain access to the room vary greatly depending on the application. Regardless of the situation, it has long been believed that the cabinets were merely simple fungible storage units and that any additional security for the cabinets should be designed into the building security in which the cabinets were stored.

For example, one of the most common cabinet locking mechanisms is a keyed lock mounted on the cabinet that operates an internal lever or slide bar that prevents the compartments of the cabinet from being opened when the cabinet is locked. Another example is an external swing-open security bar that locks every drawer. The bar is mounted to the exterior of the file cabinet and partially over the drawers and includes a keyed lock. When the lock is removed, the bar may be moved or removed to allow the drawers to be opened. The system may have individual bars and locks for each drawer or one lock and bar for multiple drawers.

Conventional methods rely on keys or secret passwords to restrict access to filed information. Keys and/or passwords are issued to individuals that are allowed access to the files and require the individual to safeguard the key or password. These systems rely on the assumption that the person possessing the key or knowing the password has proven his or her identity, assuming that this has authenticated the authorized user. However, this is not always the case. There are instances where the key or password is intentionally passed to a third person or unintentionally and illegally acquired or duplicated by a third person.

Additionally, it is possible that each file cabinet may need a different key or password. Therefore, another drawback is the shear number of keys or passwords an individual must keep track of and secure. Similarly, different individuals may have different levels of access to files requiring different keys and passwords, different storage procedures, all of which increase the cost and complexity of the system.

Despite these shortcomings, the key and password methods are among the most common file cabinet security methods used. Although alternative identification methods, such as biometric identification (e.g., fingerprints, etc.), are sometimes used for building security, they have been considered too expensive or impractical for standard cabinets. For example, a business may have tens to hundreds to thousands of file cabinets in use, depending on the type of business and the number of files being stored. As a result, it has not been practical, if it has even been considered, to increase the security of the individual cabinets. If added security was needed, the cabinets were placed in a more secure location within a building.

With the advent of more stringent security requirements for business and personal information due to industrial espionage, national security and HIPPA requirements, many individuals and businesses have had to reassess their security measures to safeguard and document access to such information. For example, an unlocked file cabinet containing medical records, business information or personal information is not very effective at limiting who can open a drawer and look at the records. Furthermore, when cabinets are locked with a conventional lock, there is no assurance that the person opening the lock is the authorized person or that that person is entitled to open that specific portion of the cabinet. Yet in many of these cases, retrofitting an office or upgrading a security system to protect standard cabinets that must be routinely accessed during business hours is either too costly or not possible.

As a result, there is a need for a system, method and apparatus for controlling access to a cabinet by using equipment that can be easily and inexpensively installed on an existing cabinet.

### SUMMARY OF THE INVENTION

The present invention provides a system, method and apparatus for controlling access to a cabinet by using equipment that can be easily and inexpensively installed on an existing cabinet. As a result, existing unsecured cabinets can be retrofitted with security equipment to control access to all or part of the contents of the cabinet without having to install or upgrade expensive or complex building security systems. The present invention provides more precise control over access to cabinets, while increasing the security through a more rigorous user authentication process and recordation of who accessed the cabinet and when the access occurred. The present invention can be incorporated into the construction of new cabinets or provided as a kit to retrofit existing cabinets. The complexity of the retrofit system will depend on the level of security that is needed for the particular application and the specific security measures that are already in place, if any. In addition, the present invention can be used to save space and consolidate filing cabinets by allocating specific compartments to individuals instead of cabinets. For example, two employees may each require a lockable compartment, so two lockable cabinets have to be provided using current equipment. The controlled access to individual compartments of a cabinet as provided by the present invention can eliminate the need for one of the lockable cabinets. As a result, the present invention is adaptable and scalable to any security application.

For example, a cabinet equipped with the present invention can provide dual custody security, allow compartments to be opened one at a time or all at once, either locally or from a remote location, provide variable security scenarios based on date, time, business hours, holidays, etc., automatic locking/unlocking according to a schedule, alarms or compartment closure, and provide audit trails detailing access and attempted access to the compartments. Access to the cabinet can be determined using user access data, such as personal identification numbers, passwords, fingerprints, hand prints, voice prints, iris scans, retina scans, facial scans, wireless signals or any combination thereof. This user access data can be input or read using various types of user interfaces, such as biometric sensors, card readers, keypads, touch screens, scanners, wireless receivers, wiegand readers or any combination thereof. Moreover, the present invention can be equipped with various sensors and alarms based on heat, smoke, position, weight, loss of power, low battery, vibration, forced entry, “open to long”, etc. The cabinets can function as stand alone security units and/or be integrated into a building security system.

More specifically, the present invention provides a cabinet that includes one or more lockable compartments, at least one locking/unlocking apparatus for the one or more lockable compartments, a user access device communicably coupled to the locking/unlocking apparatus and a power supply electrically connected to the at least one locking/unlocking apparatus and the user access device. The user access device includes a user interface, a data storage device and a processor. The user interface receives user access data. The data storage device stores the received user access data, other access activity information and the user access data for one or more authorized users. The processor compares the received user access data with the user access data for the one or more authorized users and controls the locking/unlocking apparatus based on the comparison.

The present invention also provides a system for controlling access to multiple cabinets that includes a network, a computer communicably coupled to the network and two or more cabinets. Each cabinet includes one or more lockable compartments, at least one locking/unlocking apparatus for the one or more lockable compartments, and a user access device communicably coupled to the network and the locking/unlocking apparatus. The user access device includes a user interface, a data storage device and a processor. The user interface receives the user access data. The data storage device stores the received user access data, other access activity information and user access data for one or more authorized users. The processor compares the received user access data with the user access data for the one or more authorized users and controls the locking/unlocking apparatus based on the comparison.

In addition, the present invention provides an apparatus for controlling access to a cabinet having one or more lockable compartments and at least one locking/unlocking apparatus. The apparatus includes one or more user interfaces, a data storage device and a processor. The one or more user interfaces receive user access data. The data storage device stores the received user access data, other access activity information and user access data for one or more authorized users. The processor compares the received user access data with the user access data for the one or more authorized users and controls the locking/unlocking apparatus based on the comparison.

Moreover, the present invention provides a method for controlling access to a cabinet having one or more lockable compartments, at least one locking/unlocking apparatus, one or more user interfaces, a data storage device and a processor. First, user access data is received from one of the user interfaces. The received user access data is then compared with user access data for one or more authorized users stored in the data storage device. At least one of the lockable compartments is unlocked whenever the received user access data matches the user access data for one of the authorized users. The received user access data and other access activity information are also stored in the data storage device.

Furthermore, the present invention provides a kit for retrofitting a cabinet having one or more compartments to a controlled access cabinet having one or more lockable compartments. The kit includes at least one locking/unlocking apparatus suitable for mounting within the cabinet to convert the one or more compartments to one or more lockable compartments and a user access device suitable for mounting on or within the cabinet to control the at least one locking/unlocking apparatus. The user access device includes a user interface, a data storage device and a processor. The user interface receives user access data. The data storage device stores the received user access data, other access activity information and user access data for one or more authorized users. The processor compares the received user access data with the user access data for the one or more authorized users and controls the locking/unlocking apparatus based on the comparison.

The present invention also provides a method for retrofitting a cabinet having one or more compartments to a controlled access cabinet having one or more lockable compartments. At least one locking/unlocking apparatus is installed within the cabinet to convert the one or more compartments to one or more lockable compartments. A user access device is also installed on or within the cabinet. The user access device is then connected to the at least one locking/unlocking apparatus such that the user access device controls the operation of the at least one locking/unlocking apparatus. The user access device includes a user interface, a data storage device and a processor. The user device receives user access data. The data storage device stores the received user access data, other access activity information and user access data for one or more authorized users. The processor compares the received user access data with the user access data for the one or more authorized users and controls the locking/unlocking apparatus based on the comparison.

The present invention is described in detail below with reference to the accompanying drawings.

### BRIEF DESCRIPTION OF THE DRAWINGS

For a more complete understanding of the features and advantages of the present invention, reference is now made to the detailed description of the invention along with the accompanying figures and in which:

FIG. 1A is a perspective view of a file cabinet in accordance with one embodiment of the present invention;

FIG. 1B is a perspective view of the file cabinet of FIG. 1A in which the internal equipment installed in the cabinet is shown in accordance with one embodiment of the present invention;

FIG. 2 is a block diagram of a cabinet in accordance with one embodiment of the present invention;

FIG. 3 is a side view of a locking/unlocking apparatus in accordance with one embodiment of the present invention;

FIG. 4 is a flow chart illustrating a method of controlling access to a cabinet in accordance with one embodiment of the present invention;

FIG. 5 is a block diagram of a system of controlling access to multiple cabinets in accordance with one embodiment of the present invention;

FIG. 6 is a block diagram of a cabinet in accordance with another embodiment of the present invention; and

FIGS. 7A, 7B, 7C and 7D are flowcharts illustrating a method of controlling access to a cabinet in accordance with another embodiment of the present invention.

### DETAILED DESCRIPTION OF THE INVENTION

While the making and using of various embodiments of the present invention are discussed in detail below with respect to a file cabinet, it should be appreciated that the present invention provides many applicable inventive concepts that can be embodied in a wide variety of specific contexts, including but not limited to, office furniture or any type of cabinet having drawers or doors. As a result, the terminology used and specific embodiments discussed herein are merely illustrative of specific ways to make and use the invention and do not delimit the scope of the invention.

The present invention provides a system, method and apparatus for controlling access to a cabinet by using equipment that can be easily and inexpensively installed on an existing cabinet. As a result, existing unsecured cabinets can be retrofitted with security equipment to control access to all or part of the contents of the cabinet without having to install or upgrade expensive or complex building security systems. The present invention provides more precise control over access to cabinets, while increasing the security through a more rigorous user authentication process and recordation of who accessed the cabinet and when the access occurred. The present invention can be incorporated into the construction of new cabinets or provided as a kit to retrofit existing cabinets. The complexity of the retrofit system will depend on the level of security that is needed for the particular application and the specific security measures that are already in place, if any. In addition, the present invention can be used to save space and consolidate filing cabinets by allocating specific compartments to individuals instead of cabinets. For example, two employees may each require a lockable compartment, so two lockable cabinets have to be provided using current equipment. The controlled access to individual compartments of a cabinet as provided by the present invention can eliminate the need for one of the lockable cabinets. As a result, the present invention is adaptable and scalable to any security application.

For example, a cabinet equipped with the present invention can provide dual custody security, allow compartments to be opened one at a time or all at once, either locally or from a remote location, provide variable security scenarios based on date, time, business hours, holidays, etc., automatic locking/unlocking according to a schedule, alarms or compartment closure, and provide audit trails detailing access and attempted access to the compartments. Access to the cabinet can be determined using user access data, such as personal identification numbers, passwords, fingerprints, hand prints, voice prints, iris scans, retina scans, facial scans, wireless signals or any combination thereof. This user access data can be input or read using various types of user interfaces, such as biometric sensors, card readers, keypads, touch screens, scanners, wireless receivers, wiegand readers or any combination thereof. Moreover, the present invention can be equipped with various sensors and alarms based on heat, smoke, position, weight, loss of power, low battery, vibration, forced entry, open to long, etc. The cabinets can function as stand alone security units and/or be integrated into a building security system.

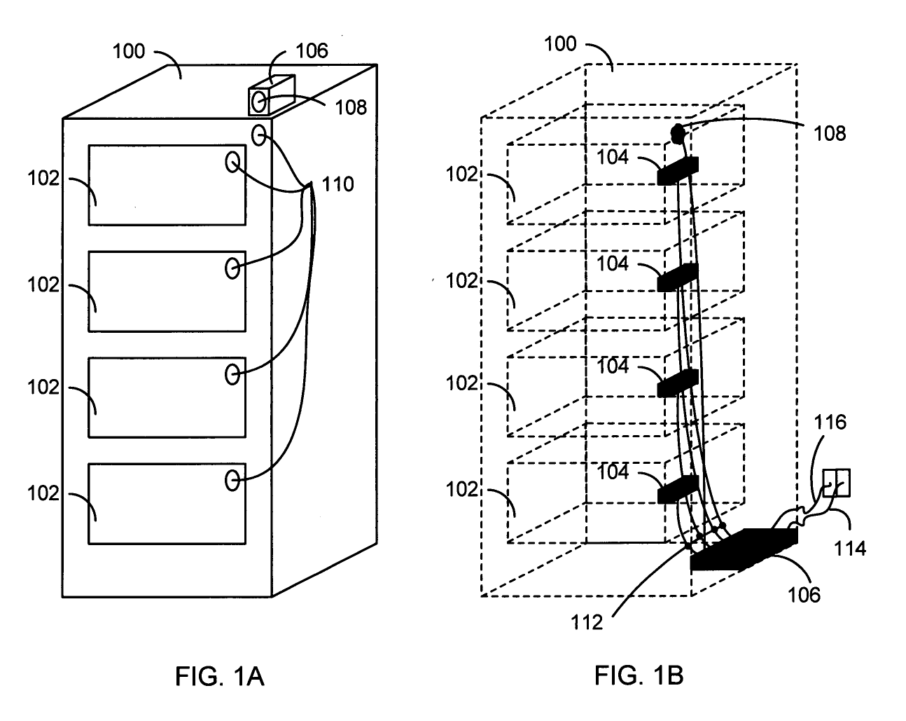

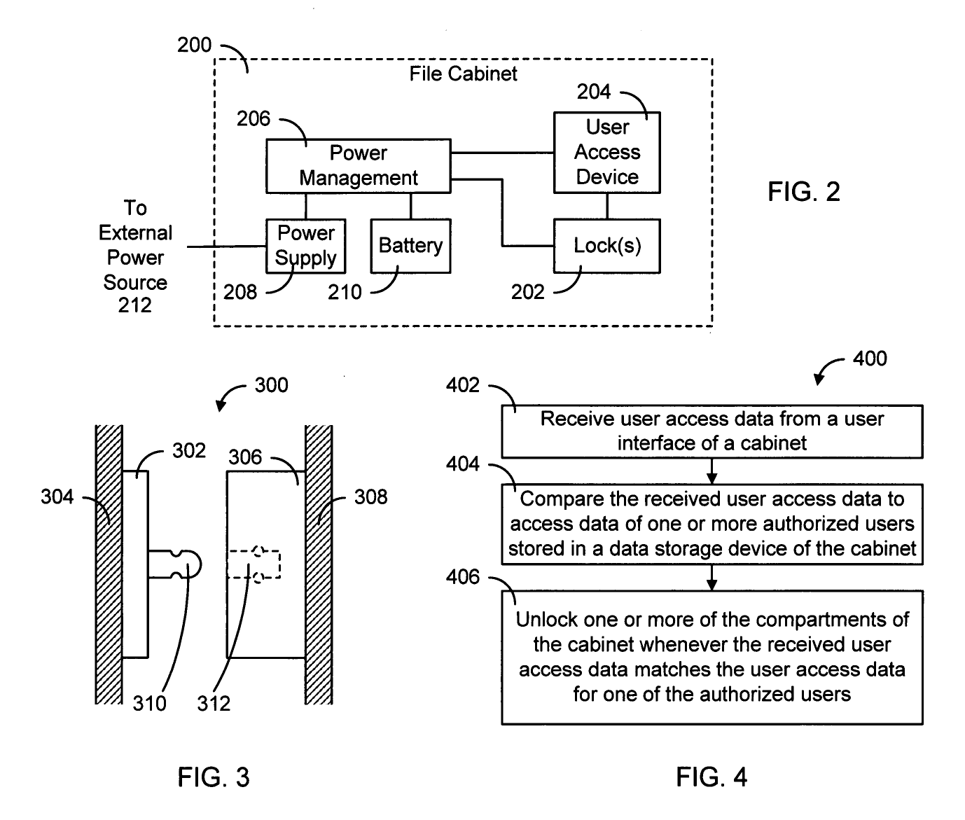

Now referring to FIGS. 1A and 1B, perspective views of a cabinet 100 in accordance with one embodiment of the present invention are shown. The present invention provides a cabinet 100 that includes one or more lockable compartments 102, at least one locking/unlocking apparatus 104 for the one or more lockable compartments 102, a user access device 106 communicably coupled to the locking/unlocking apparatus 104 and a power supply (not shown in FIG. 1A; integrated into user access device 106 in FIG. 1B) electrically connected to the at least one locking/unlocking apparatus 104 and the user access device 106. As used herein, a cabinet 100 may include a file cabinet, a storage cabinet, a portion of a desk or any other type of office/industrial furniture that contains compartments (drawers or doors). Moreover, the cabinet 100 may be of different sizes to accommodate the different needs of the business or hospital, e.g., files, documents, receipts, samples, supplies, medicines, tools and the like. Additionally, the one or more lockable compartments 102 may be of different sizes as well. Furthermore, the size of the one or more lockable compartments 102 may vary in a cabinet 100, for example, having one or more larger lockable compartments 102 at the bottom and one or more smaller lockable compartments 102 at the top. Likewise, various components can be communicably coupled together using simple wires, communication cables, circuit board interconnects and traces, optical cables, wireless connections or any other means that allow one device to communicate with or control another device.

The locking/unlocking apparatus 104 can be any electrically operated locking mechanism, such as a solenoid driven latch, plunger or rod, an electromagnetic latch, or any other controllable locking/unlocking means. The locking/unlocking apparatus 104 can be installed in any practical location within the cabinet 100 (e.g., at the back, side, front, top or bottom of the compartment 102). Moreover, the number of locking/unlocking apparatuses 104 used will depend on the application and range from a single locking/unlocking apparatus 104 to secure all the compartments 102 in the cabinet 100 to one locking/unlocking apparatus 104 to secure each compartment 102 in the cabinet 100. Typically, the locking/unlocking apparatus 104 is selected to automatically lock when the corresponding lockable compartment 102 is closed and to remain in a normally locked position without power, which prevents access by simply interrupting the power to the cabinet 100. As shown in FIG. 1B, each locking/unlocking apparatus 104 can be communicably connected to the user access device by individual wires 112 (e.g., 18/2). The communication can be as simple as applying voltage to a relay or solenoid, or a complex as a coded or multiplexed wireless transmission to a receiver installed on the locking/unlocking apparatus 104. For example, each locking/unlocking apparatus 104 can have a separate communication channel.

The control portion of the user access device 106 is typically located internally to the cabinet 100 as shown in FIG. 1B. The location within the cabinet 100 may be varied depending on the space available and the level of security needed. The control portion of the user access device 106 may be positioned on the underside of the cabinet 100 or on the back wall of the cabinet 100. Furthermore, a specific housing may be constructed within the cabinet 100 to accommodate the control unit. The housing may be engineered to prevent access to the control unit. The user access device 106 includes a user interface 108, a data storage device (integrated into user access device 106) and a processor (integrated into user access device 106). The components of the user access device 106 can be integrated into a single unit or distributed within or on the cabinet 100. The user interface 108 receives the user access data from a user attempting to access the cabinet 100. Each cabinet 100 can be equipped with one or more user interfaces 108. For example, a keyed lock or user interface 108 can be installed at positions 110 in FIG. 1A. Moreover, a single user interface 108 can be used to gain access to only a single lockable compartment 102 based on a security level associated with the user or inputs provided at the time of the access request (e.g., keypad, selection buttons, touch screen, voice command, etc.). The user interface 108 may include a biometric sensor, a card reader, a keypad, a touch screen, a scanner, a wireless receiver, a wiegand reader or any combination thereof. Likewise, the user access data may include a personal identification number, a password, a fingerprint, a hand print, a voice print, an iris scan, a retina scan, a facial scan, a wireless signal or any combination thereof.

The data storage device stores the received user access data, other access activity information and the user access data for one or more authorized users. The data storage device may include a memory, a hard drive, a disk drive, a database or any combination thereof. The other access activity information may include a date, an attempted access time, an unlock time, a lock time, a result of the comparison of the received user access data with the user access data for the one or more authorized users, a status of the locking/unlocking apparatus or a combination thereof. The processor compares the received user access data with the user access data for the one or more authorized users and controls the locking/unlocking apparatus 104 based on the comparison. The processor can also determine which of the one or more lockable compartments 104 to unlock based on a security level associated with the user access data for the one or more authorized users. In addition, the processor can communicate with a building or central security center via a standard local area network connection 114. The processor can also be connected to one or more sensors, such as a heat sensor, a smoke sensor, a lockable compartment position sensor, a weight sensor, a loss of power sensor, a low battery sensor, a vibration sensor, a forced entry sensor, an “open to long” sensor or any combination thereof.

The power supply may include an AC-DC converter, one or more batteries or any combination thereof. In addition, the power supply may include a power management device (integrated into user access device 106) electrically connected to the user access device 106 and the locking/unlocking apparatus 104, a primary power supply electrically connected to the power management device and a secondary power supply electrically connected to the power management device. The primary power supply is connected to an external power source 116, such as a building AC outlet. The secondary power supply typically comprises one or more batteries. Often such batteries will provide backup power to the system for four to six hours and are recharged when primary power is restored.

Additionally, a screen, monitor, touch screen, keyboard or keypad (not shown) may be in connected to the cabinet 100 to display information, warnings, procedures, identities, time, date or allow input for a user. The cabinet 100, therefore, can be equipped with numerous accessories, such as a wireless interface communicably coupled to the user access device 106, a network interface communicably coupled to the user access device 106, an input/output interface communicably coupled to the user access device 106, one or more sensors communicably coupled to the user access device 106, one or more alarms communicably coupled to the user access device 106, a timer communicably coupled to the user access device 106, or a power management device electrically connected to the power supply and one or more batteries.

Note that the user access data may be stored a token (e.g., card, badge, key, disk, hard drive, jump drive or other object capable of storing information) carried by the user or located on or about the cabinet 100. For example, access to a cabinet 100 may require a biometric user access data from the user access device 108 (e.g., a fingerprint scan) and insert an encoded security card into a card reader. When biometric user access data is used, the level of security of the cabinet may be varied by adjusting the stringency of the match between the biometric user access data and the stored biometric access data. In addition, redundant systems may be used which would include two or more authentication comparisons. For example, the individual may be required to input a password and submit a fingerprint scan, submit a fingerprint scan and a retinal scan or require two or more individuals to submit fingerprint scans before access is granted. The redundant authentication will allow even a greater level of security.

Furthermore, the present invention provides a kit for retrofitting a cabinet having one or more compartments to a controlled access cabinet 100 having one or more lockable compartments 102. The kit includes at least one locking/unlocking apparatus 104 suitable for mounting within the cabinet 100 to convert the one or more compartments to one or more lockable compartments 102 and a user access device 106 suitable for mounting on or within the cabinet 100 to control the at least one locking/unlocking apparatus 104. The user access device 106 includes a user interface 108, a data storage device and a processor. The user interface 108 receives user access data. The data storage device stores the received user access data, other access activity information and user access data for one or more authorized users. The processor compares the received user access data with the user access data for the one or more authorized users and controls the locking/unlocking apparatus 104 based on the comparison.

Similarly, the present invention provides a method for retrofitting a cabinet having one or more compartments to a controlled access cabinet 100 having one or more lockable compartments 102. At least one locking/unlocking apparatus 104 is installed within the cabinet 100 to convert the one or more compartments to one or more lockable compartments 102. A user access device 106 is also installed on or within the cabinet 100. The user access device 106 is then connected to the at least one locking/unlocking apparatus 104 such that the user access device controls the operation of the at least one locking/unlocking apparatus 104. The user access device 106 includes a user interface, a data storage device and a processor. The user device receives user access data. The data storage device stores the received user access data, other access activity information and user access data for one or more authorized users. The processor compares the received user access data with the user access data for the one or more authorized users and controls the locking/unlocking apparatus 104 based on the comparison.

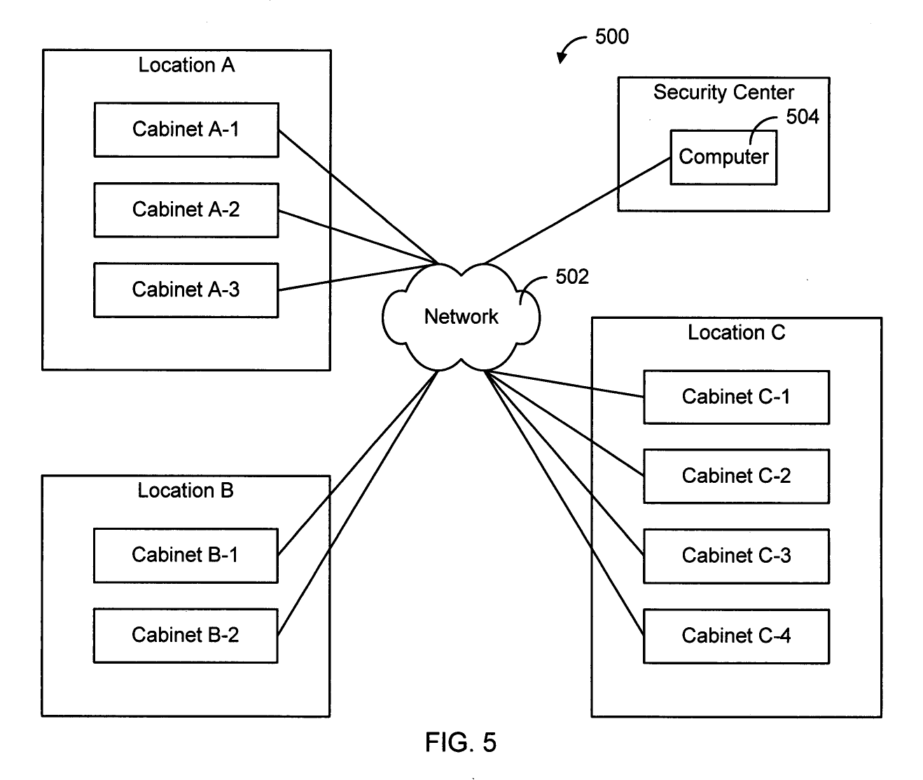

Referring now to FIG. 2, a block diagram of a cabinet 200 in accordance with one embodiment of the present invention is shown. The cabinet 200 includes an apparatus that controls access to the cabinet 200 having one or more lockable compartments and at least one locking/unlocking apparatus 202. The apparatus includes a user access device 204 that is communicably coupled to the at least one locking/unlocking apparatus 202 and includes one or more user interfaces, a data storage device and a processor. The one or more user interfaces receive user access data. The data storage device stores the received user access data, other access activity information and user access data for one or more authorized users. The processor compares the received user access data with the user access data for the one or more authorized users and controls the locking/unlocking apparatus 202 based on the comparison. This particular embodiment also includes a power management device 206 electrically connected to the at least one locking/unlocking apparatus 2002, the user access device 204, a power supply 208 and one or more batteries 210. The power supply 208 is then electrically connected to an external power source 212.

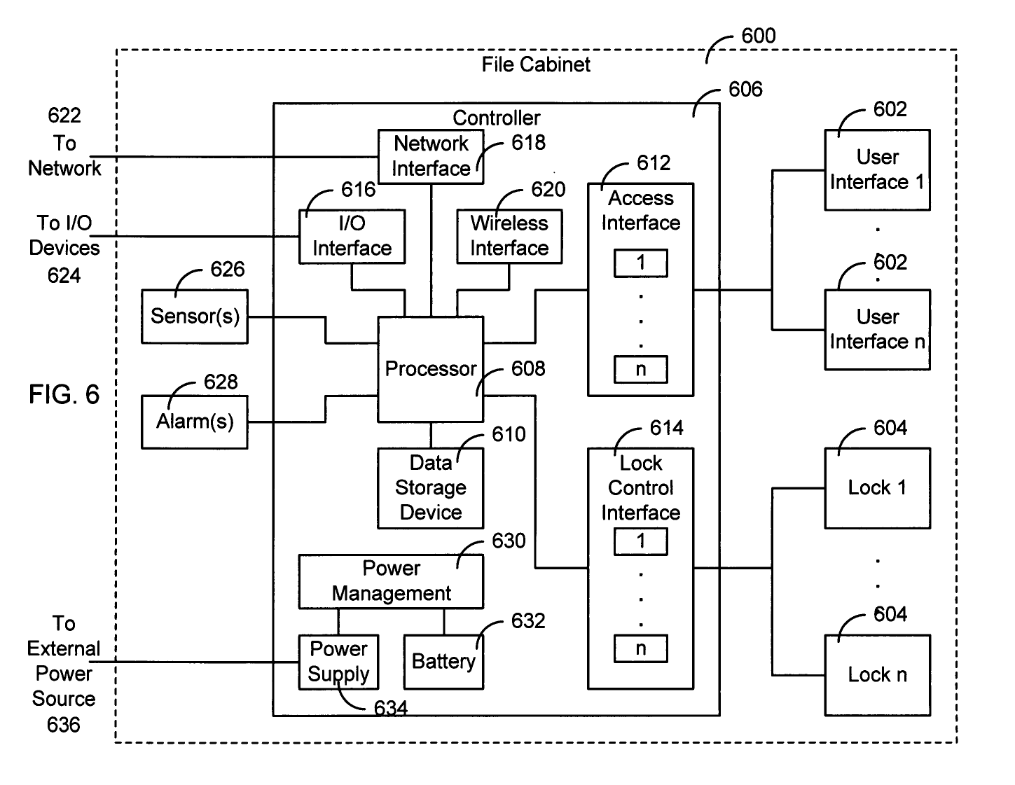

Now referring to FIG. 3, a side view of a locking/unlocking apparatus 300 in accordance with one embodiment of the present invention is shown. The locking/unlocking apparatus 300 includes a first section 302 attached to the back of a lockable compartment 304 and a second section 306 attached to the inside back portion of the cabinet 308. The two section 302 and 306 are aligned such that a locking pin 310 attached to the first section 302 is inserted into a pin receiving mechanism 312 in the second section 306. The pin receiving mechanism 312 securely holds the locking pin 310 in place until the user access device signals the locking/unlocking apparatus 300 to change to an unlocked status. As previously discussed, this is only one type of locking/unlocking apparatus and does not limit the scope of the invention in that any type or configuration of locking/unlocking apparatus can be used with the present invention. For example, each locking mechanism may include a solenoid attached to the cabinet wherein the solenoid extends an extendable member that contacts a receiving mechanism attached to the one or more lockable compartments. Likewise, each locking mechanism may include a motor attached to the cabinet wherein the motor extends an extendable member that contacts a receiving mechanism attached to the one or more lockable compartments.

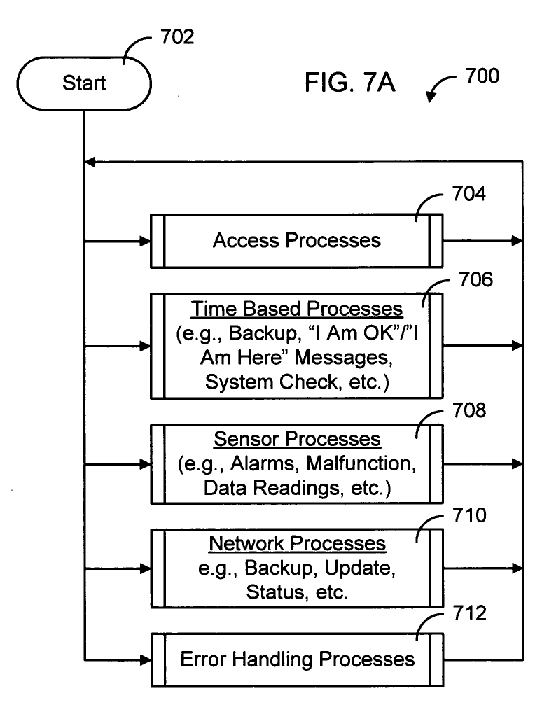

Referring now to FIG. 4, a flow chart illustrating a method 400 of controlling access to a cabinet in accordance with one embodiment of the present invention is shown. As previously discussed, the cabinet has one or more lockable compartments, at least one locking/unlocking apparatus, one or more user interfaces, a data storage device and a processor. First, user access data is received from one of the user interfaces of the cabinet in block 402. The received user access data is then compared with user access data for one or more authorized users stored in the data storage device of the cabinet in block 404. At least one of the lockable compartments of the cabinet is unlocked whenever the received user access data matches the user access data for one of the authorized users in block 406. The received user access data and other access activity information are also stored in the data storage device. This method can be implemented as a computer program embodied on a computer readable medium wherein each step comprised one or more code segments.

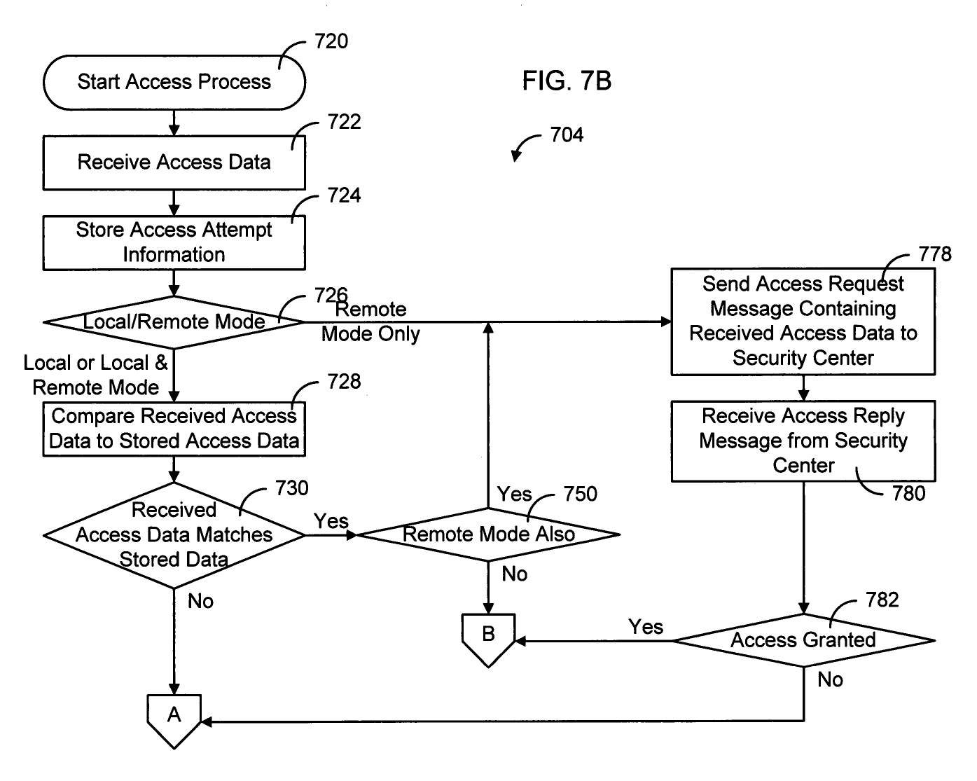

Now referring to FIG. 5, a block diagram of a system 500 of controlling access to multiple cabinets in accordance with one embodiment of the present invention is shown. The system includes a network 502, a computer 504 communicably coupled to the network 502 and two or more cabinets (any two cabinets selected from A-1, A-2, A-3, B-1, B-2, C-1, C-2, C-3, C-4). Each cabinet (A-1, A-2, A-3, B-1, B-2, C-1, C-2, C-3, C-4) includes one or more lockable compartments, at least one locking/unlocking apparatus for the one or more lockable compartments, and a user access device communicably coupled to the network 502 and the locking/unlocking apparatus. The user access device includes a user interface, a data storage device and a processor. The user interface receives the user access data. The data storage device stores the received user access data, other access activity information and user access data for one or more authorized users. The processor compares the received user access data with the user access data for the one or more authorized users and controls the locking/unlocking apparatus based on the comparison.

As shown, Location A includes Cabinet A-1, Cabinet A-2 and Cabinet A-3; Location B includes Cabinet B-1 and Cabinet B-2; and Location C includes Cabinet C-1, Cabinet C-2, Cabinet C-3 and Cabinet C-4. Locations A, B and C can be located locally (within the same building) or remotely to one another and to the Security Center. The computer 504 in the Security Center can be used to monitor and/or control the Cabinets connected to the network 502. For example, the computer 504 can monitor the status of sensors and alarms in the Cabinets, maintain a second access log, and provide redundant user access data verification. In such a case, the processor within the Cabinets will send the received user access data to the computer 504 via the network 502 and the computer 504 will compare the received user access data with the user access data for the one or more authorized users. The computer 504 can take active (log the information, deny access and alert the Security Center) or passive action (log the information and alert the Security Center) based on the comparison.

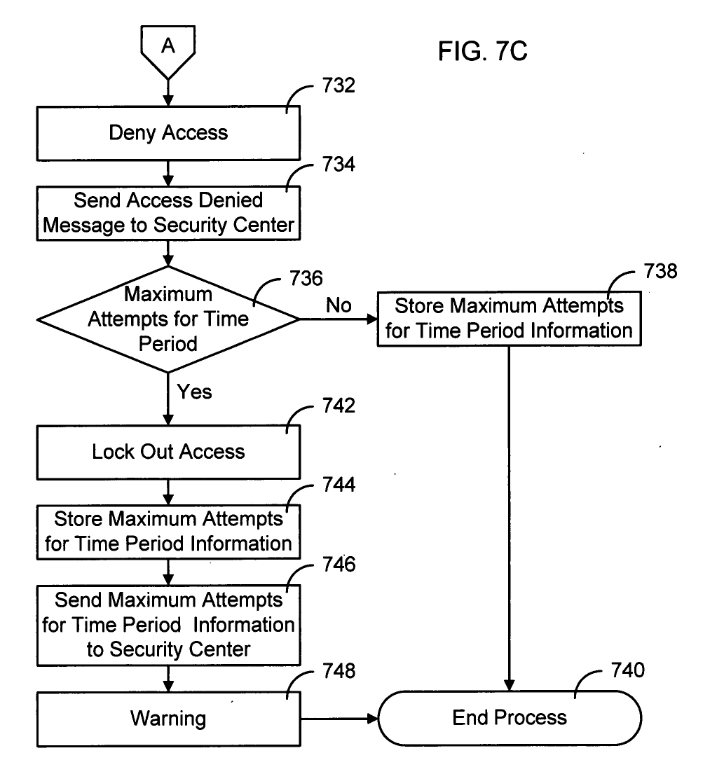

Referring now to FIG. 6, a block diagram of a cabinet 600 in accordance with another embodiment of the present invention is shown. The cabinet 600 includes one or more user interfaces 602, one or more locking/unlocking apparatuses 604 and a controller 606 communicably coupled to the one or more user interfaces 602 and one or more locking/unlocking apparatuses 604. The controller 606 includes a processor 608, a data storage device 610, an access interface 612 and a lock control interface 614. The access interface 612 allows the multiple user interfaces 602 to communicate with and be controlled by the processor 608. Similarly, the lock control interface 614 allows the processor 608 to control multiple locking/unlocking apparatuses 604. The controller 606 may also include one or more other interfaces (input/output interface 616, network interface 618, wireless interface 620) communicably coupling the processor 608 to various external devices (e.g., network 622 and input/output devices 624). The processor 606 may also be communicably coupled with one or more sensors 626 and one or more alarms 628. The controller 606 is powered by a power management device 630 electrically connected to one or more batteries 632 and a power supply 634. The power supply 634 is electrically connected to an external power source 636. Note that the various types of user interfaces 602, locking/unlocking apparatuses 604, data storage devices 610, sensors 626, alarms 629, batteries 632 and power supplies 634 that can be used with the present invention have been previously described.

With respect to the use of alarms 628, the present invention can activate the alarm 628 in response to a variety of circumstances, e.g., an attempt at unauthorized entry, the cabinet 600 remaining unlocked or open for an extended period of time, one or more compartments remaining open for an extended period of time, the incorrect match of user access data, an attempt to move the cabinet 600, the tilting of the cabinet 600, the moving of the cabinet 600, the interruption of power to the cabinet 600 or force one or more drawers to open. The alarm 628 may be internally mounted, externally mounted, attached to a network or combinations thereof. Furthermore, the alarm may be in the form of a display, a light, a silent alarm, a siren, a buzzer, a noise, the activation of a video camera, the activation of an audio recorder, a signal to a remote location or combinations thereof. The alarm 628 further heightens security through alerting others to unauthorized activities.

The present invention can also include a recording mechanism that records information relating to the access of the cabinet 600. The recording mechanism may record a video image, a photograph, an audio track, a time, a date, a duration of access, the number of times an individual access a cabinet 600, the number of times a cabinet 600 has been accessed or combinations thereof. The recording feature may be particularly useful in performing audits. Furthermore, the controller 606 may perform routines designating particular protocols for specific scenarios. For example, the controller 606 may lock and unlock all of the one or more compartments at a particular time (e.g., in the case of normal operating hours) or the controller 606 may lock the compartments for a given period of time (e.g., holidays). The controller 606 may record the number of accesses and limit that to a specified number of times. The controller 606 may also have a time and date stamp associated with each unlocking sequence.

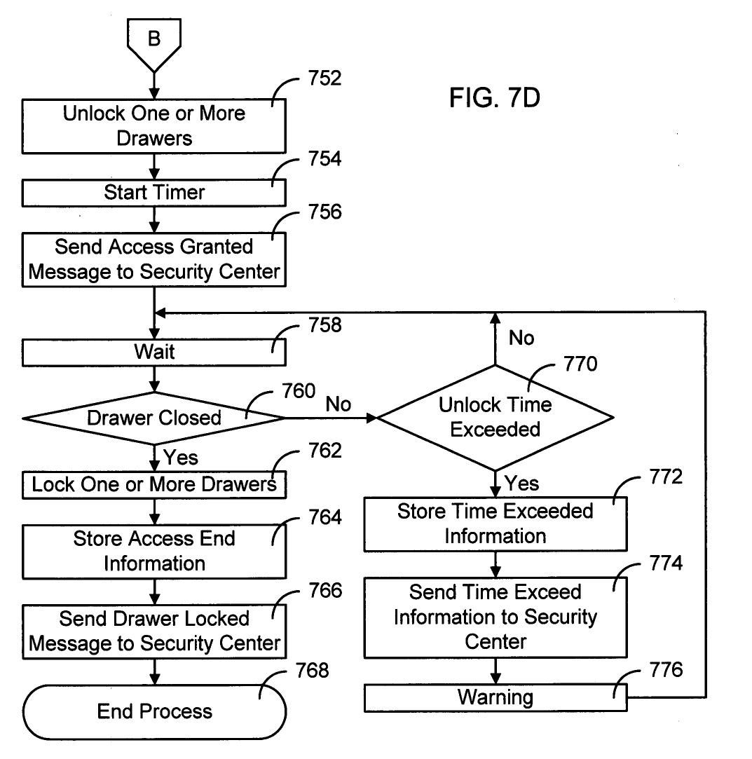

Now referring to FIGS. 7A, 7B, 7C and 7D, flowcharts illustrating a method 700 of controlling access to a cabinet in accordance with another embodiment of the present invention are shown. The process 700 starts in block 702 and performs various processes as necessary based on various operating parameters and inputs. The processes may include access processes 704, time based processes 706, sensor processes 708, network processes 710 and error handling processes 712. One such access process 702 will be described in more detail in reference to FIGS. 7B, 7C and 7D. The other processes will vary depending on the application. The time based processes 706 may include scheduled data backups, “I AM OK” or “I AM NOT OK” messages that respond to query messages from a security center computer via a network, periodic “I AM HERE” messages sent to the security center computer via the network, periodic system checks and other scheduled tasks. The sensor processes 708 monitor and take action based on data received from one or more sensors, e.g., activating/deactivating alarms, detecting and reporting malfunctions, collecting data readings from the one or more sensors, etc. The network processes 710 may include periodic backups, software updates, data updates, status reports, etc. The error handling processes 712 respond to various errors that may occur during operation of the system.

The access process 704 starts in block 720. User access data is received in block 722 and the access attempt information is stored in block 724. If the controller is set to local mode or local and remote mode as determined in decision block 726, the received user access data is compared to the stored access data in block 728. If the received user access data does not match the stored access data, as determined in decision block 730, access is denied in block 732 and an access denied message is sent to the security center in block 734. If a maximum number of attempts have not been reached for a time period, as determined in decision block 736, the maximum attempts for the time period information is stored in block 738 and the access process ends in block 740. If, however, the maximum number of attempts for the time period has been reached, as determined in decision block 736, access is locked out in block 742 and the maximum number of attempts for the time period information is stored in block 744. The maximum number of attempts for the time period information is also sent to the security center in block 748 and the access process ends in block 740.

If, however, the received user access data matches the stored data in decision block 703, and the controller is not also set to remote mode, as determine in decision block 750, one or more of the lockable compartments are unlocked in block 752, a timer is started in block 754 and an access granted message is sent to the security center in block 756. After a specified time has elapsed in block 758, and if the lockable compartment 760 is closed, as determined in decision block 760, the one or more lockable compartments are locked in block 762. Access end information is stored in block 764, a compartment locked message is sent to the security center in block 766 and the access process ends in block 768. If, however, the compartment is not closed, as determined in decision block 760, and a maximum unlock time has not been exceeded, as determined in decision block 770, the controller returns to the wait period in block 758 and proceeds as previously described. If, however, the unlock time for the compartment has been exceeded, as determined in decision block 770, the time exceeded information is stored in block 772. The time exceeded information is also sent to the security center in block 774 and a warning is issued in block 776. The controller returns to the wait period in block 758 and proceeds as previously described.

If, however, the controller is set to remote mode only, as determined in decision block 726, or the controller is set to local and remote mode as determined in decision block 750, the controller sends an access request message containing the received user access data to the security center in block 778. Once an access reply message is received from the security center in block 780 and the message indicates that access is not to be granted, as determined in decision block 782, the controller denies access in block 732 and proceeds as previously described. If, however, the message indicates that access is granted, as determined in decision block 782, the controller unlocks one or more of the compartments in block 752 and proceeds as previously described.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

What is claimed is:

1. A cabinet comprising:
one or more lockable compartments;
at least one locking/unlocking apparatus for the one or more lockable compartments;
a user access device communicably coupled to the locking/unlocking apparatus comprising a user interface that receives user access data, a data storage device that stores received user access data, other access activity information and user access data for one or more authorized users, and a processor that compares the received user access data with the user access data for the one or more authorized users and controls the locking/unlocking apparatus based on the comparison; and
a power supply electrically connected to the at least one locking/unlocking apparatus and the user access device.

2. The cabinet as recited in claim 1, wherein the data storage device comprises a memory, a hard drive, a disk drive, a database or a combination thereof.

3. The cabinet as recited in claim 1, wherein the user interface comprises a biometric sensor, a card reader, a keypad, a touch screen, a scanner, a wireless receiver or a combination thereof.

4. The cabinet as recited in claim 1, wherein the one or more lockable compartments comprise a door or a drawer.

5. The cabinet as recited in claim 1, wherein the user access data comprises a personal identification number, a password, a fingerprint, a hand print, a voice print, an iris scan, a retina scan, a facial scan, a wireless signal or a combination thereof.

6. The cabinet as recited in claim 1, wherein the other access activity information comprises a date, an attempted access time, an unlock time, a lock time, a result of the comparison of the received user access data with the user access data for the one or more authorized users, a status of the locking/unlocking apparatus or a combination thereof.

7. The cabinet as recited in claim 1, wherein the power supply comprises:
a power management device electrically connected to the user access device and the locking/unlocking apparatus;
a primary power supply electrically connected to the power management device; and
a secondary power supply electrically connected to the power management device.

8. The cabinet as recited in claim 1, wherein the power supply comprises an AC-DC converter, one or more batteries or a combination thereof.

9. The cabinet as recited in claim 1, wherein the user access device and the power supply comprise a single control unit.

10. The cabinet as recited in claim 1, wherein the user access device further comprises one or more of the following:
a wireless interface communicably coupled to the processor;
a network interface communicably coupled to the processor;
an input/output interface communicably coupled to the processor;
one or more sensors communicably coupled to the processor;
one or more alarms communicably coupled to the processor;
a timer communicably coupled to the processor; or
a power management device electrically connected to the power supply and one or more batteries.

11. The cabinet as recited in claim 10, wherein the one or more sensors comprise a heat sensor, a smoke sensor, a lockable compartment position sensor, a weight sensor, a loss of power sensor, a low battery sensor, a vibration sensor or a combination thereof.

12. The cabinet as recited in claim 1, further comprising one or more of the following:
a wireless interface communicably coupled to the user access device;
a network interface communicably coupled to the user access device;
an input/output interface communicably coupled to the user access device;
one or more sensors communicably coupled to the user access device;
one or more alarms communicably coupled to the user access device;
a timer communicably coupled to the user access device; or
a power management device electrically connected to the power supply and one or more batteries.

13. The cabinet as recited in claim 1, wherein the user interface is separated from, but communicably coupled to, a controller comprising the data storage device and the processor.

14. The cabinet as recited in claim 13, wherein the controller further comprises:
one or more access interfaces communicably coupling the processor with each of the user interfaces; and
one or more lock control interfaces communicably coupling the processor with each of the locking/unlocking apparatuses.

15. The cabinet as recited in claim 1, wherein each lockable compartment has a corresponding user interface and locking/unlocking apparatus.

16. The cabinet as recited in claim 1, wherein the processor determines which of the one or more lockable compartments to unlock based on a security level associated with the user access data for the one or more authorized users.

17. A system for controlling access to multiple cabinets, comprising
a network;
a computer communicably coupled to the network; and
two or more cabinets, each cabinet comprising:
one or more lockable compartments,
at least one locking/unlocking apparatus for the one or more lockable compartments, and
a user access device communicably coupled to the network and the locking/unlocking apparatus, the user access device comprising a user interface that receives user access data, a data storage device that stores received user access data, other access activity information and user access data for one or more authorized users, and a processor that compares the received user access data with the user access data for the one or more authorized users and controls the locking/unlocking apparatus based on the comparison.

18. The system as recited in claim 17, wherein the processor sends the received user access data to the computer via the network.

19. The system as recited in claim 18, wherein the computer compares the received user access data with the user access data for the one or more authorized users.

20. An apparatus for controlling access to a cabinet having one or more lockable compartments and at least one locking/unlocking apparatus, comprising:
one or more user interfaces that receive user access data;
a data storage device that stores received user access data, other access activity information and user access data for one or more authorized users; and
a processor that compares the received user access data with the user access data for the one or more authorized users and controls the locking/unlocking apparatus based on the comparison.

21. A method for controlling access to a cabinet having one or more lockable compartments, at least one locking/unlocking apparatus, one or more user interfaces, a data storage device and a processor, the method comprising the steps of:
receiving user access data from one of the user interfaces;
comparing the received user access data with user access data for one or more authorized users stored in the data storage device;
unlocking at least one of the lockable compartments whenever the received user access data matches the user access data for one of the authorized users; and
storing the received user access data and other access activity information in the data storage device.

22. A kit for retrofitting a cabinet having one or more compartments to a controlled access cabinet having one or more lockable compartments, comprising:
at least one locking/unlocking apparatus suitable for mounting within the cabinet to convert the one or more compartments to one or more lockable compartments; and
a user access device suitable for mounting on or within the cabinet to control the at least one locking/unlocking apparatus, the user access device comprising a user interface that receives user access data, a data storage device that stores received user access data, other access activity information and user access data for one or more authorized users, and a processor that compares the received user access data with the user access data for the one or more authorized users and controls the locking/unlocking apparatus based on the comparison.

23. A method for retrofitting a cabinet having one or more compartments to a controlled access cabinet having one or more lockable compartments, comprising:
installing at least one locking/unlocking apparatus within the cabinet to convert the one or more compartments to one or more lockable compartments; and
installing a user access device on or within the cabinet;
connecting the user access device to the at least one locking/unlocking apparatus such that the user access device controls the operation of the at least one locking/unlocking apparatus; and
the user access device comprising a user interface that receives user access data, a data storage device that stores received user access data, other access activity information and user access data for one or more authorized users, and a processor that compares the received user access data with the user access data for the one or more authorized users and controls the locking/unlocking apparatus based on the comparison.
